(19) United States
(12) Patent Application Publication
(10) Pub. No.: US 2023/0324045 A1
(43) Pub. Date: Oct. 12, 2023

(54) COOKING APPLIANCE MONITORING SYSTEM FOR AN APPARATUS FOR COOKING AND A METHOD THEREOF

(71) Applicant: Tisya Singh, West Windsor, NJ (US)

(72) Inventor: Tisya Singh, West Windsor, NJ (US)

(73) Assignee: Tisya Singh, West Windsor, NJ (US)

(21) Appl. No.: 17/717,089

(22) Filed: Apr. 10, 2022

(51) Int. Cl. F23N 5/00; F23B 30/00; F23L 1/00; F23L 9/06

(52) U.S. Cl. CPC F23N 5/00; F23B 5/02; F23L 1/00; F23L 9/06; F23B 40/00

(57) ABSTRACT

An apparatus for cooking, a cooking appliance monitoring system, and a method of monitoring a cooking appliance are provided. The monitoring system collects and processes signals from sensors linked to the cooking appliance. Further, the monitoring system determines attributes of parameters associated with the cooking appliance and stores the attributes in a cloud-based system and stores the metadata about the attributes in a blockchain.

### TECHNOLOGICAL FIELD

The present disclosure generally relates to an apparatus for cooking, and more particularly relates to systems and methods of monitoring a cooking appliance for pollutants.

### BACKGROUND

Since the ancient era humans have been using fire to cook food. During that period traditional way of cooking maybe as crude as three stone fires to other basic variants.

These stoves were inefficient and required comparatively long hours for cooking and there was no control mechanism to regulate heat. These traditional stoves were not only burning fuel inefficiently, but also emitting high amount of greenhouse gases and pollutants that immediately harm the household and in the long-term damages the environment. With the development of science and during post-industrial era, humankind started to understand and experience the adverse impact of inefficient use of natural resources and also started feeling the detrimental effects of climate change. Since then, significant time and resources have been invested to understand impact of inefficient usages of natural resources and means to improve efficiency, thereby leading to sustainable development.

The global emission composition includes Short-lived climate forcers (SLCFs)/Short-lived climate pollutants (SLCPs) include compounds such as black carbon (BC), methane (CH₄), tropospheric ozone (O₃), and many hydrofluorocarbons (HFCs). These compounds have short lifetimes in the atmosphere compared to long-lived GHGs (LL-GHGs). Although their concentrations/loadings can be elevated by human-related activities and emissions, these compounds do not accumulate in the atmosphere over multi-decadal to centennial time scales and longer, and so their effects on climate are shorter lived, predominantly in days to decades following their emissions.

Cookstoves fueled by solid fuels are one of the key contributors to SLCPs such as BC, CH₄ and ozone (O₃) precursors like carbon monoxide (CO) and volatile organic compounds (VOCs). These are compounds trap heat at the lower atmosphere and surface.

With the development of science an growing interest in energy sector, many research and technological enhancement have been carried out to attain highest level of energy efficiency. Still about 40% of the world population lack access to clean energy and rely on rudimentary stoves that burn wood, dung or coal for cooking. These stoves account for 20% of black carbon emission in the atmosphere, which is neither good for environment nor for the users. Black carbon is responsible for various indoor air pollution related diseases. In addition, traditional stoves release brown carbon particles, along with gases that are implicated in climate warming (including carbon dioxide, ozone-producing gases and methane).

Therefore, there is a need for a system to monitor the combustion in a stove and the emission due to combustion.

It is an object of the present invention to provide an improved efficiency and monitored cooking appliance that overcomes some or all of the disadvantages of the prior art.

### BRIEF SUMMARY

Accordingly, to monitor the combustion in a stove and the emission due to combustion, a system and method for monitoring a cooking appliance is provided.

Some example embodiments disclosed herein provide a cooking appliance monitoring system. The system comprises a cooking appliance monitoring unit configured to monitor a set of parameters associated with the cooking appliance, wherein the cooking appliance monitoring system is configured to be coupled to the cooking appliance. The system may include a communication unit coupled to the cooking appliance monitoring unit wherein the communication unit configured to communicate a set of emission attributes to a server wherein metadata value associated with the set of emission attributes is recorded in a blockchain.

According to some example embodiments, the cooking appliance monitoring unit further comprises a plurality of sensors coupled to a cooking appliance wherein the plurality of sensors configured to sense the set of parameters of the cooking appliance and generate a signal corresponding to each parameter of the set of parameters. The cooking appliance monitoring unit may include a data processor coupled to the plurality of sensors wherein the data processor configured to receive and process the signals corresponding to each parameter of the set of parameters to determine, the set of emission attributes associated with the cooking appliance.

According to some example embodiments, the set of parameters comprises at least one of, usage of the cooking appliance, quantity of a fuel burnt in the cooking appliance, and emission produced by the cooking appliance.

According to some example embodiments, the communication unit comprises a data-logger coupled to the plurality of sensors wherein the data logger configured to store the set of parameters of the cooking appliance over a predetermined period of time.

According to some example embodiments, the data-logger of the communication unit comprises an internet of things (IOT) interface provided with a subscriber identity module (SIM) wherein the IOT interface configured to communicate the set of emission attributes to the server. The Internet of things (IoT) describes physical objects (or groups of such objects) with sensors, processing ability, software, and other technologies that connect and exchange data with other devices and systems over the Internet or other communications networks

According to some example embodiments, a thermoelectric device may be coupled to the cooking appliance wherein the thermoelectric device configured to generate electricity from heat generated by the cooking appliance.

According to some example embodiments, the thermoelectric device may be further configured to generate an electrical signal and transmit the electrical signal to an external device wherein the external device is charged by the electrical signal.

In another embodiment, an apparatus for cooking comprising a housing, a fuel feeder configured to fit within the housing to accept fuel and a fire-pot configured to fit within the housing to maintain burning of the fuel. The fire-pot further comprises a first array of holes provided at lower side of the fire-pot. The fire-pot may include a second array of holes provided at lower side of the fire-pot; and a third array of holes provided at upper side of the fire-pot.

According to some example embodiments, first array of holes configured to provide oxygen to initiate burning of the fuel, the second array of holes configured to provide oxygen to maintain burning of the fuel and the third array of holes configured to circulate flames produced by burning of the fuel, within the fire-pot.

According to some example embodiments, the first array of holes has at least 6 holes, the second array of holes has at least 14 holes, and the third array of holes has at least 28 holes.

According to some example embodiments, the first array of holes has a diameter ranging from 4 milli-meter (mm) to 6 mm, the second array of holes has a diameter ranging from 5 mm to 7 mm, and the third array of holes has a diameter ranging from 6 mm to 8 mm.

According to some example embodiments, the fire-pot further comprises a top opening provided at an upper end of the fire-pot wherein the top opening has diameter ranging from 125 mm to 135 mm. The fire-pot may further comprises a bottom opening provided at a lower end of the fire-pot wherein the bottom opening ranging from 45 mm to 55 mm.

According to some example embodiments, the shape of the fuel feeder is round and the edges of the apparatus for cooking are curved.

According to some example embodiments, the fire-pot comprises of at least an insulating material.

According to some example embodiments, the fire-pot held within the housing by a single bolt.

According to some example embodiments, the apparatus for cooking comprises of at least a corrosion-resistant material.

According to some example embodiments, the apparatus for cooking comprises of at least a high temperature-resistant material.

According to some example embodiments, the apparatus for cooking is a stove.

In another embodiment, a method for monitoring a cooking appliance is provided. The method comprises monitoring a set of parameters associated with a cooking appliance. The method may include determining a set of emission attributes associated with the cooking appliance based on the set of parameters. Further, the method includes communicating the set of emission attributes to a serve. The method may include recording metadata value associated with the set of emission attributes in a blockchain. Further, the method may include transmitting data pertaining to the set of emission attributes to a mobile device.

According to some example embodiments, the method further comprises sensing the set of parameters of the cooking appliance by plurality of sensors. The method may include generating a signal corresponding to each parameter of the set of parameters by the plurality of sensors. Further the method may include, processing the signal corresponding to each parameter of the set of parameters to determine the set of emission attribute. Further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale. The accompanying drawings illustrate one or more embodiments of the present disclosure, features and benefits thereof, and together with the written description, serve to explain the principles of the present invention. Wherever possible, the same reference numbers are used throughout the drawings to refer to the same or like elements of an embodiment, and wherein:

FIG. 1 shows an exemplary block diagram of cooking appliance monitoring system interfacing with a cloud and coupled to a cooking appliance;

FIG. 2 shows the block diagram of the exemplary cooking appliance monitoring system linked to the cloud, blockchain and a mobile device;

FIG. 3A shows a side view of the exemplary cooking appliance disclosed in FIG. 1;

FIG. 3B shows an exploded view of the exemplary cooking appliance disclosed in FIG. 1;

FIG. 4A shows a side view of the exemplary fire-pot of the cooking appliance disclosed in FIG. 3A and FIG. 3B;

FIG. 4B shows a front view of the exemplary fire-pot of the cooking appliance disclosed in FIG. 3A and FIG. 3B;

FIG. 5 shows the exemplary cooking appliance disclosed in FIG. 3A and FIG. 3B with base top and fuel feeding cut;

FIG. 6A shows an exemplary wood feeding chamber and the fire pot as shown in FIG. 4A and FIG. 4B;

FIG. 6B shows the exemplary wood feeding chamber as shown in 6A attached to the fire pot as shown in FIG. 4A and FIG. 4B;

FIG. 7A shows a front view of a full assembly of the cooking appliance disclosed in FIG. 3A and FIG. 3B;

FIG. 7B shows a side view of a full assembly of the cooking appliance with an indication of the wood feeding chamber and the fire pot;

FIG. 7C shows a side view of a full assembly of the cooking appliance disclosed in FIG. 3A and FIG. 3B;

FIG. 8A shows a side view of the fire pot with holes;

FIG. 8B shows a front view of the fire pot with holes;

FIG. 9A shows a tray;

FIG. 9B shows a round bar;

FIG. 9C shows a base plate;

FIG. 10A shows a grill cover;

FIG. 10B shows a front view of the grill cover housing the cooking appliance;

FIG. 10C shows a side view of the grill cover housing the cooking appliance;

FIG. 10D shows a back view of the grill cover housing the cooking appliance; and

FIG. 11 shows a flow chart of process for monitoring the cooking appliance.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

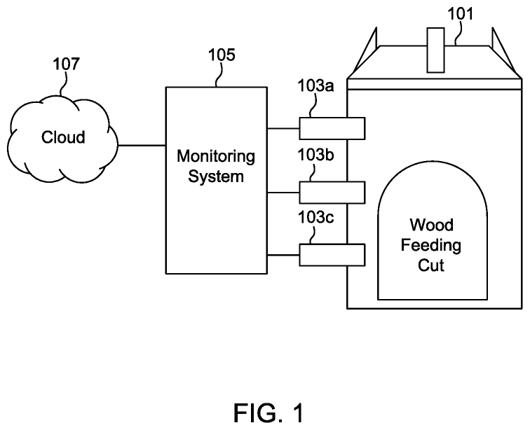

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure. FIG. 1 illustrates a block diagram of the cooking appliance monitoring system 105 according to an embodiment of the present invention. The cooking appliance monitoring system 105 comprises a cooking appliance monitoring unit to monitor a set of parameters associated with operation of a cooking appliance and a communication unit, coupled to the cooking appliance monitoring unit, to communicate with cloud 107 or a server.

In this description and the following claims cloud 107 is defined as a model for enabling on-demand network access to a shared pool of configurable computing resources (e.g., networks, servers, storage, applications, and services). The definition of cloud 107 is not limited to any of the other numerous advantages that can be obtained from such a model when properly deployed. For instance, cloud 107 is currently employed in the marketplace so as to offer ubiquitous and convenient on-demand access to the shared pool of configurable computing resources.

A cloud 107 model can be composed of various characteristics such as on-demand self-service, broad network access, resource pooling, rapid elasticity, measured service, and so forth. A cloud 107 computing model may also come in the form of various service models such as, for example, Software as a Service (“SaaS”), Platform as a Service (“PaaS”), and Infrastructure as a Service (“IaaS”). The cloud model may also be deployed using different deployment models such as private cloud, community cloud, public cloud, hybrid cloud, and so forth.

The cooking appliance monitoring unit 105 comprises a plurality of sensors 103a, 103b and 103c, at least one data processor, and a memory storage. The plurality of sensors 103a, 103b and 103c are coupled to the cooking appliance. Further the sensors 102a, 103b and 103c sense the set of parameters of the cooking appliance and generate an electric signal corresponding to magnitude of each sensed parameter of the set of parameters.

The set of parameters may comprise but not limited to parameters like a usage pattern of the cooking appliance, heat loss, quantity of a fuel burnt in the cooking appliance in a predetermined duration of time, or emission produced by the cooking appliance during operation.

The data processor is a data processing unit of the cooking appliance monitoring unit. The data processor is configured to receive the electric signals from the plurality of sensors 103a,103b and 103c. Further, the processor receives electric signals corresponding to each parameter of the set of parameters and processes the same to determine, the set of emission attributes associated with the cooking appliance.

A sensor is a device that produces an output signal for the purpose of sensing of a physical phenomenon. Further, the sensor maybe a device, module, machine or a subsystem that detects changes in its environment and transmits the information to a processor. In the present invention the sensors 103a, 103b and 103c detect at least but not limited to greenhouse gases, pollutants and heat from the cooking appliance 101 and relays the measurements to the monitoring system 105.

Further, the hardware used to implement the function of the data processor described in connection with the embodiment disclosed herein may be implemented or performed with a software-configurable processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A software-configurable processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

The memory storage is a non-transitory computer-readable medium or non-transitory processor-readable medium and configured to store functions for the working of the data processor as one or more instructions or code. The steps of a method or algorithm disclosed herein may be embodied in a processor-executable software module which may reside on a non-transitory computer-readable or processor-readable storage medium. Non-transitory computer-readable or processor-readable storage medium may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

In an embodiment, the monitoring system 105 is communicatively coupled to a cloud 107 to relay and process signals from the cooking appliance 101.

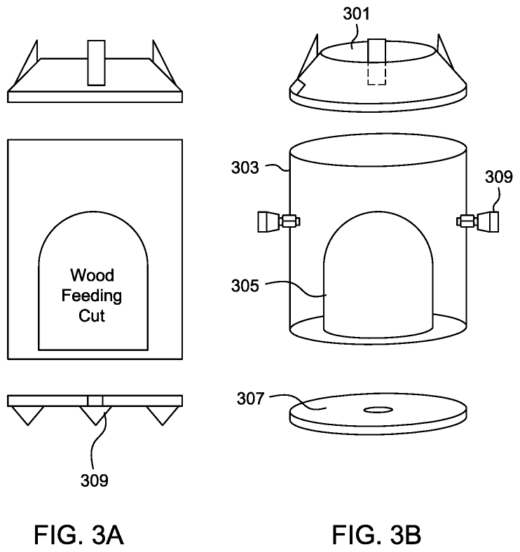

In another embodiment, the monitoring system 105 is connected to the cooking appliance which is further illustrated in FIG. 3A and FIG. 3B.

The communication unit is a communication interface coupled to the cooking appliance monitoring unit 105. According to some example embodiment, the communication unit is closely connected to the cooking appliance monitoring unit 105. Further, the communication unit may comprise a data-logger which is coupled to the sensors 103a, 103b, and 103c. The data-logger may be configured to store the set of parameters of the cooking appliance over a predetermined period of time. The data-logger may further comprises an internet of things (IOT) interface provided with a SIM wherein the IOT interface may be configured to communicate the set of emission attributes to the server.

The communication interface may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network is coupled directly or indirectly to the user equipment via the cloud 107. In an example embodiment, the system may be integrated in the user equipment.

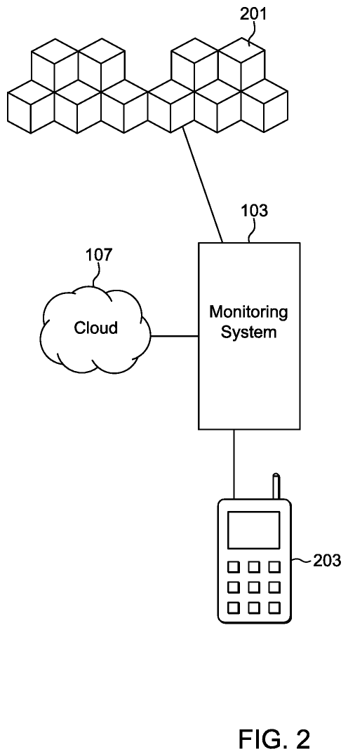

FIG. 2 shows a cooking appliance monitoring system 103 communicatively coupled to a mobile device 203, a blockchain 201 and the cloud 107.

In some example embodiments the mobile device 203 is uniquely identified by a SIM coupled to the mobile device 203.

In some embodiments the monitoring system comprises a thermo-electric generator which generates electricity from the heat produced by the cooking appliance. In an example embodiment the electricity generated is used to charge the mobile device 203. In another embodiment the electricity generated is used for lighting purposes.

In another embodiment, the communication unit may be an external unit coupled to the cooking appliance monitoring unit via a wireless or a wired connection to receive a set of emission attributes from the data processor of the cooking appliance monitoring unit 105 and communicate, via a wired or a wireless connection.

Emission attributes may be type and amount of a pollutant. The type, for example, sulfur dioxide (SO2), and the amount, for example, the quantity of SO2 emitted by the cooking appliance. The emissions can be further classified as short-lived climate forcers (SCLFs) such as black carbon and long-lived greenhouse gases (LL-GHGs) like carbon di-oxide. The attributes are mentioned as examples and should not be construed to be limiting.

The monitoring system 103 may be connected to the blockchain 201. The emission attributes from the sensors is processed and uploaded to the cloud 107. In an example embodiment, the emission attributes may be processed in the cloud 107. Metadata associated with the emission attributes is recorded in the blockchain 201.

The blockchain 201 technology is based on existing communication protocols (e.g., HTTP), cryptography (Public key cryptography), distributed peer-to-peer sharing mechanisms and a distributed set of databases kept in synchronization based on time. The blockchain technology is a technology that permanently records events or transactions on a network in a transparent, auditable, and irrefutable way. A blockchain ledger is stored on each blockchain node participating in or comprising a network. Blockchain nodes include, but are not limited to grid elements, coordinators, network appliances, servers, mobile devices, work stations or any networked client that can interface with an IP-based network and can operate an operating system capable of processing blocks. Blockchain is a loose specification rather than a specific implementation, which is capable of unlocking monopoly power over information in infrastructure systems for telecommunications, healthcare, finance, energy, and government. The use of blockchains within the systems and methods of the present invention provide that it is not merely an abstract idea, since it is inextricably tied to internet technology.

FIG. 3A shows the front view of the cooking appliance 101. Particularly, the blown up front view of outer frame of the cooking appliance 101 is shown. The outer frame is broadly divided into a top cover, body frame 303 and a bottom pan. The top cover is of thickness 1 mm and is further attached to a pan stands which is of thickness 2 mm. The body frame 303 has a wood feeding cut 305 and is of 1 mm thickness. The bottom pan has conical supports 311 attached and is of 10 mm thickness In some example embodiments the cooking appliance is a stove.

FIG. 3B shows the perspective view of the blown up outer frame of the cooking appliance 101. Further, 303 indicates the body frame of the cooking appliance. In certain embodiments the body frame forms the enclosing of the stove this may be operated by the means of a knob 309. The cooking appliance 101 may be assembled and dismantled by the using the knob 309 this provides an element of ease of operation. Further, the knob 309 is made of Bakelite or other heat resistant materials to facilitate injury free handling by users.

In FIG. 3B a cut 305 in the frame provides a provision for loading fuel. A top cover 301 is located above the body frame 303. In certain embodiments, the pan stand 301 is circular in shape and has the provision for pan stand to hold a cooking utensil such as but not limited to a frying pan, a wok and a pressure cooker. At the bottom of the body frame 303 is a bottom pan 307. In some example embodiments, the bottom pan 307 is circular in shape and has conical edges at the bottom to support the weight of the cooking appliance 101 and provides a slight elevation with respect to the ground. The entirety of the outer body which comprises of the body frame 303, top cover 301 and bottom pan 307 in an embodiment is made of stainless steel which has a low rate of corrosion and high temperature resistive strength. In an example embodiment the overall height of the hollow cylindrical body frame 303 is 206 mm the diameter of the body frame is 20 mm the wood feeding cut out of the body frame 303 is 103 mm wide and 112 mm tall. Further, the base diameter of the top section is 206 mm and the top diameter is 129 mm. Also, the diameter of the bottom pan is 206 mm. However, other metals and alloys can be used as deemed appropriate by a person having ordinary skill in the art.

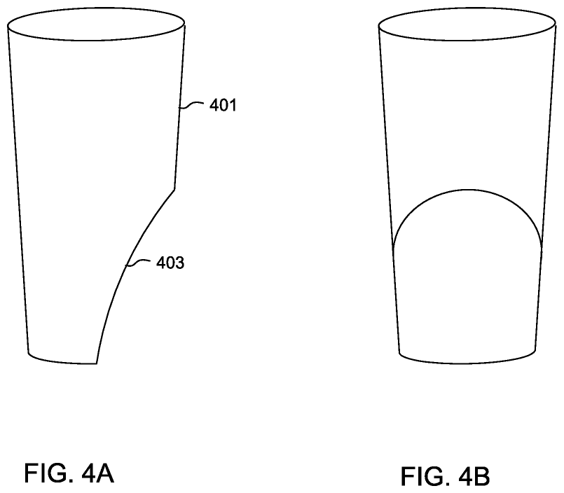

FIG. 4A is the side view of the fire pot 401 and FIG. 4B provides the front view of the fire pot 401. The fire pot is of 1 mm thickness and has an arch shaped groove 403 at the bottom part which is 100 mm tall cut in up to 50 mm from the base and is circular at the top with a diameter of 127 mm and the overall height of the fire pot 401 is 242 mm. In an example embodiment the cross-section of the bottom portion of the fire pot 401 is smaller than the cross-section of the top side. The function of the fire pot 401 is to enclose the fuel during combustion and channel the heat upwards into the pan stand and top cover 301.

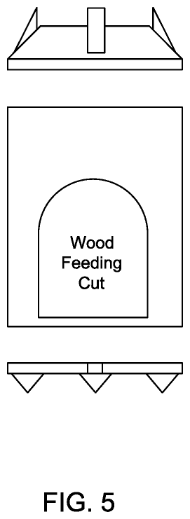

FIG. 5 is front view of the cooking appliance 101 with a hole in the bottom portion to allow a means for fuel feeding. The hole in the lower side is rectangular and on the top side is shaped as an arch.

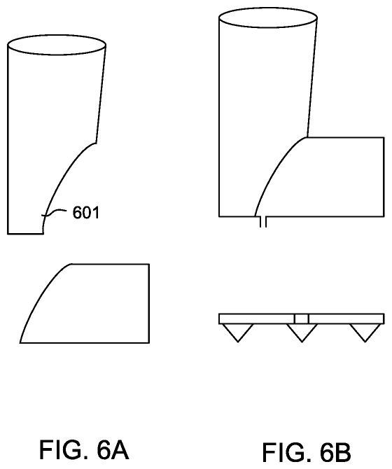

FIG. 6A is a sideview of the fire pot 401 and a fuel feeding chamber 601 which is a hollow elongated tube shape with a rectangular base and a curved top, the fuel feeding chamber 601 is of 101 mm height. Also, the fuel feeding chamber has different lengths at the top and the bottom length at the top is 101 mm and at the bottom is 203 mm. Further, FIG. 6B shows a side view of the fire pot 401 attached to the fuel feeding chamber 601 In a certain embodiment the hollow fuel feeding chamber 601 is shaped to fit the arch shaped groove at the bottom part of the fire pot 401.

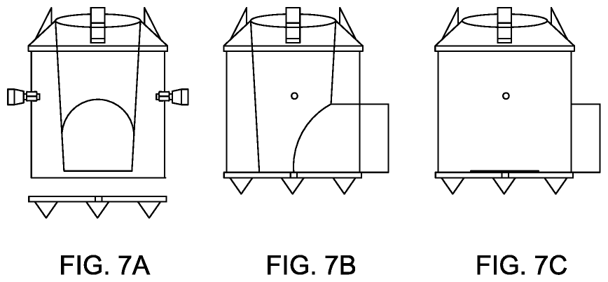

FIG. 7A is a front view of a full assembly of the cooking appliance 101 where the outer frame is shown transparent to indicate the location of the fire pot 401 and the feeding chamber 601. FIG. 7B is a side view of the full assembly of the cooking appliance and here again the outer frame is deliberately shown transparent to indicate the location of the fire pot 401 and the feeding chamber 601 relative to the outer frame. FIG. 7C is the side view of the full assembly of the cooking appliance. The overall height of the full assembly is 294 mm the height from the base to a knob 309 is 152 mm. The length of the protrusion by the fuel feeding chamber 601 from the outer frame is 50 mm

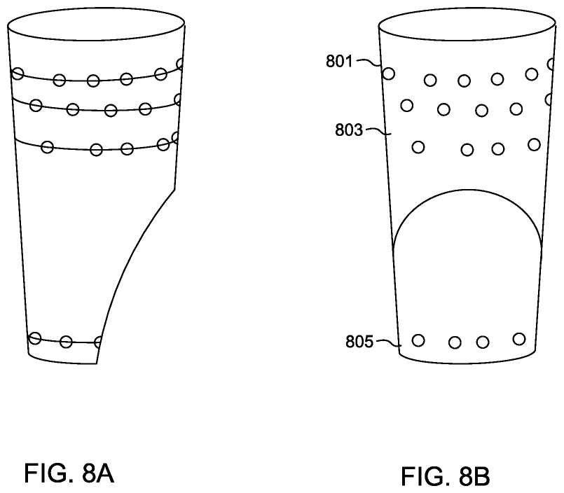

FIG. 8A shows the fire pot 401 as shown in FIG. 4A with holes arranged across the circumference of fire pot. According to some example embodiments a first set of holes 805 is provided across an arc near the bottom of the fire pot. The first set of holes have a cross-section of 5 mm and are 7 in number. Further, a second set of holes 803 is provided above the first set of holes and above the arch opening of the fire pot. The second set of holes are 7 mm cross-section and are 15 in number. Also a third set of holes is provided near the top of the fire pot 401. The third set of holes are 7 mm in diameter and are 15 in number. In some example embodiments the set of holes 801, 802 and 803 are arranged in concentric circles parallel to top rim of the fire pot 401. The invention is not limited by the sets of holes, cross-section or the number of holes.

In another embodiment the first set of holes 805 are configured to aide in initiating burning of fuel by facilitating Oxygen supply. The second set of holes 803 are configured to provide Oxygen thereby maintaining the fuel burn. The third set of holes 801 are configured to circulate heat and/or flames produced as a result of fuel burn. The said arrangement is not limited to the scenario disclosed, other arrangements as per a person having ordinary skill in the area can also be employed.

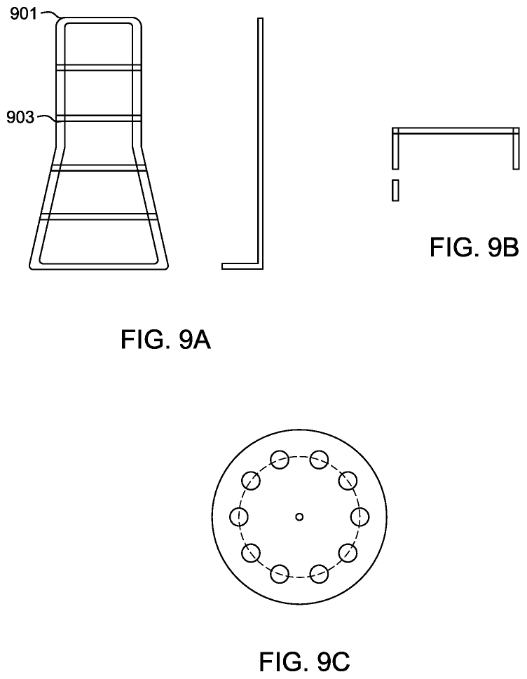

FIG. 9A may represent a tray for feeding fuel into the cooking appliance and a bar for handling the fuel. The tray has different widths of 100 mm and 154 mm on either side and a overall length of 304 mm. Further, the tray is enclosed in a wall 901 and is divided into various chambers 903 where each chamber is 60 mm long. A bar of length 304 mm is provided with the tray to handle the fuel during the burning process and is especially used to kindle a flame or spread the burning fuel evenly. FIG. 9B discloses a cross-section of the tray with the tray height of 50 mm.

FIG. 9C shows the base plate of the cooking appliance 101. The conical supports provided in the bottom side where the supports have a cross-section of 20 mm.

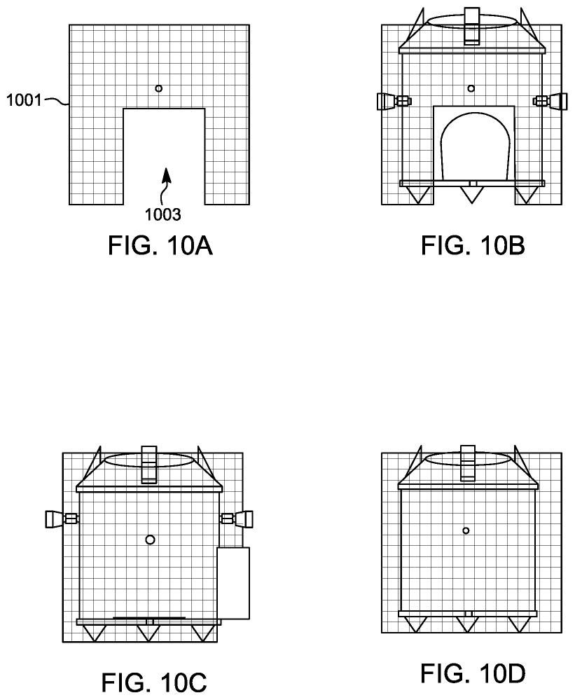

FIG. 10A shows, according to some example embodiment, a grill cover in form of a perforated sieve material made of mild steel of any other material or alloy as appropriate. FIG. 10B shows a front view of the grill cover enclosing the cooking appliance 101. Further, FIG. 10C shows a side view of the grill cover enclosing the cooking appliance 101. Also, FIG. 10D discloses the back view of the said enclosure.

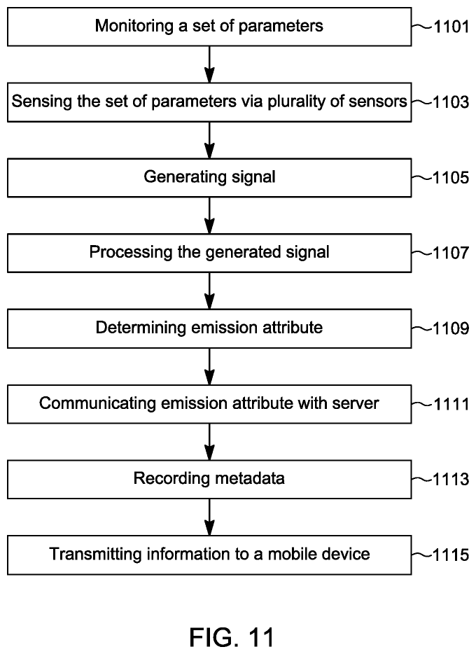

FIG. 11 illustrates a flow diagram of a method for monitoring the cooking appliance 101, in accordance with an example embodiment. It will be understood that each block of the flow diagram of the method may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory of the system, employing an embodiment of the present invention and executed by a processor. As will be appreciated, any such computer program instructions may be loaded onto a computer or other programmable appliance (for example, hardware) to produce a machine, such that the resulting computer or other programmable appliance implements the functions specified in the flow diagram blocks. These computer program instructions may also be stored in a computer-readable memory that may direct a computer or other programmable appliance to function in a particular manner, such that the instructions stored in the computer-readable memory produce an article of manufacture the execution of which implements the function specified in the flowchart blocks. The computer program instructions may also be loaded onto a computer or other programmable appliance to cause a series of operations to be performed on the computer or other programmable appliance to produce a computer-implemented process such that the instructions which execute on the computer or other programmable appliance provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method illustrated by the flowchart diagram of FIG. 11 is monitoring a cooking appliance. Fewer, more, or different steps may be provided.

Step 1101 of the method is directed to monitoring a set of parameters associated with the cooking appliance 101.

A plurality of sensors are employed at step 1103 to continuously measure the set of parameters. The sensors are placed at the cooking appliance and are directed to measure the set of parameters.

The sensors typically convert the physical parameters being monitored to electronic signals which are generally proportional to the magnitude or the intensity of the parameters at step 1105.

The electronic signals are processed by the monitoring system at step 1107.

The monitoring system based on the processed electronic signals and predetermined standards and algorithms determines the emission attributes at step 1109.

Further, the emission attributes are transmitted to a server or a cloud at step 1111. In another embodiment the steps 1109 and 1111 may typically be performed in the cloud or at the server.

Due to the need in maintaining the integrity of the recorded attributes a blockchain ledger is employed to record the metadata of the attributes. The metadata may be, for example the cryptographic hash values of the attributes, is recorded in the blockchain in step 1113. This step renders the recorded attributes tamper proof thereby enhancing integrity.

Further, the recorded attributes may be transmitted to a mobile device at step 115 in case such a need arises.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A cooking appliance monitoring system comprising:
a cooking appliance monitoring unit configured to monitor a set of parameters associated with a cooking appliance, wherein the cooking appliance monitoring system is configured to be coupled to the cooking appliance; and
a communication unit coupled to the cooking appliance monitoring unit wherein the communication unit configured to communicate a set of emission attributes to a server wherein metadata value associated with the set of emission attributes is recorded in a blockchain.

2. The system of claim 1, wherein the cooking appliance monitoring unit further comprises:
a plurality of sensors coupled to a cooking appliance wherein the plurality of sensors configured to sense the set of parameters of the cooking appliance and generate a signal corresponding to each parameter of the set of parameters; and
a data processor coupled to the plurality of sensors wherein the data processor configured to receive and process the signals corresponding to each parameter of the set of parameters to determine the set of emission attributes associated with the cooking appliance.

3. The system of claim 2, wherein the set of parameters comprises at least one of, usage of the cooking appliance, quantity of a fuel burnt in the cooking appliance, and emission produced by the cooking appliance.

4. The system of claim 1, wherein the communication unit comprises:
a data-logger coupled to the plurality of sensors wherein the data logger configured to store the set of parameters of the cooking appliance over a predetermined period of time.

5. The system of claim 4, wherein the data-logger of the communication unit comprises an internet of things (IOT) interface provided with a subscriber identity module (SIM) wherein the IOT interface configured to communicate the set of emission attributes to the server.

6. The system of claim 1, further comprising a thermoelectric device coupled to the cooking appliance wherein the thermoelectric device configured to generate electricity from heat generated by the cooking appliance.

7. The system of claim 6, wherein the thermoelectric device is further configured to generate an electrical signal and transmit the electrical signal to an external device wherein the external device is charged by the electrical signal.

8. An apparatus for cooking comprising:
a housing;
a fuel feeder configured to fit within the housing to accept fuel;
a fire-pot configured to fit within the housing to maintain burning of the fuel, wherein the fire-pot further comprises:
a first array of holes provided at lower side of the fire-pot;
a second array of holes provided at lower side of the fire-pot; and
a third array of holes provided at upper side of the fire-pot.

9. The apparatus of claim 8, wherein
the first array of holes configured to provide oxygen to initiate burning of the fuel;
the second array of holes configured to provide oxygen to maintain burning of the fuel; and
the third array of holes configured to circulate flames produced by burning of the fuel, within the fire-pot.

10. The apparatus of claim 8, wherein the first array of holes has at least 6 holes, the second array of holes has at least 14 holes, and the third array of holes has at least 28 holes.

11. The apparatus of claim 8, wherein the first array of holes has a diameter ranging from 4 milli-meter (mm) to 6 mm, the second array of holes has a diameter ranging from 5 mm to 7 mm, and the third array of holes has a diameter ranging from 6 mm to 8 mm.

12. The apparatus of claim 8, wherein the fire-pot further comprises:
a top opening provided at an upper end of the fire-pot wherein the top opening has diameter ranging from 125 mm to 135 mm; and
a bottom opening provided at a lower end of the fire-pot wherein the bottom opening ranging from 45 mm to 55 mm.

13. The apparatus of claim 8, wherein the shape of the fuel feeder is round and edges of the cooking apparatus are curved.

14. The apparatus of claim 8, wherein the fire-pot comprises of at least an insulating material.

15. The apparatus of claim 8, wherein the fire-pot held within the housing by a single bolt.

16. The apparatus of claim 8, wherein the apparatus comprises of at least a corrosion-resistant material.

17. The apparatus of claim 8, wherein the apparatus comprises of at least a high temperature-resistant material.

18. The apparatus of claim 8, wherein the apparatus is a stove.

19. A method for monitoring a cooking appliance, the method comprising:
monitoring a set of parameters associated with the cooking appliance;
determining a set of emission attributes associated with the cooking appliance based on the set of parameters;
communicating the set of emission attributes to a server;
recording metadata value associated with the set of emission attributes in a blockchain; and
transmitting data pertaining to the set of emission attributes to a mobile device.

20. The method of claim 19, wherein the method further comprises:
sensing the set of parameters of the cooking appliance by plurality of sensors;
generating a signal corresponding to each parameter of the set of parameters by the plurality of sensors;
processing the signal corresponding to each parameter of the set of parameters to determine the set of emission attributes.
